(19) United States
(12) Patent Application Publication
(10) Pub. No.: US 2018/0257910 A1
(43) Pub. Date: Sep. 13, 2018

(54) MOVEABLE MAINTENANCE ASSEMBLIES FOR ELEVATORS

(71) Applicant: Otis Elevator Company, Farmington, CT (US)

(72) Inventor: Bi Xiong, Gien (FR)

(21) Appl. No.: 15/903,126

(22) Filed: Feb. 23, 2018

(30) Foreign Application Priority Data
Mar. 9, 2017 (EP) 17305251.5

(51) Int. Cl. B66B 5/00

(52) U.S. Cl. CPC B66B 5/0068; B66B 5/0062; B66B 5/0087

(57) ABSTRACT

Moveable elevator car maintenance assemblies having a fixed portion fixedly attached to the elevator car, the fixed portion forming a portion of a frame of the elevator car, a moveable portion arranged within the fixed portion, the moveable portion moveable relative to the fixed portion from a first position to a second position, and at least one component removably mounted to the moveable portion. The at least one component is removable from the moveable portion when the moveable portion is in the second position.

### CROSS-REFERENCE TO RELATED APPLICATIONS

This application claims the benefit of European Application No. 17305251.5 filed on Mar. 9, 2017, which is incorporated herein by reference in its entirety.

### BACKGROUND

The subject matter disclosed herein generally relates to elevator systems and, more particularly, to maintenance assemblies that are manually moveable to enable easy access to components of elevators.

Certain components of elevator cars are mounted to the exterior of the elevator car and thus may be difficult for mechanics to access and perform maintenance thereon. For example, safety blocks that engage with a guide rail may be located at the top of uprights of the frame of an elevator car, and thus access into the elevator shaft may be required to perform maintenance thereon. Further, the mounting elements, such as bolts or other fasteners, may be difficult to access even with a mechanic located within the elevator shaft. Thus, it may be advantageous to enable easier access to various elevator components.

### SUMMARY

According to some embodiments, moveable maintenance assemblies for elevator cars are provided. The moveable maintenance assemblies include a fixed portion fixedly attached to the elevator car, the fixed portion forming a portion of a frame of the elevator car, a moveable portion arranged within the fixed portion, the moveable portion moveable relative to the fixed portion from a first position to a second position, and at least one component removably mounted to the moveable portion. The at least one component is removable from the moveable portion when the moveable portion is in the second position.

In addition to one or more of the features described above, or as an alternative, further embodiments of the moveable maintenance assemblies may include that the at least one component is at least one of an electronic safety actuator, a safety block, or a roller guide.

In addition to one or more of the features described above, or as an alternative, further embodiments of the moveable maintenance assemblies may include that the moveable portion is fixedly attached to the fixed portion when in the first position.

In addition to one or more of the features described above, or as an alternative, further embodiments of the moveable maintenance assemblies may include one or more mounting fasteners to fix the moveable portion in the first position, the one or more mounting fasteners removable to enable the moveable portion to move relative to the fixed portion.

In addition to one or more of the features described above, or as an alternative, further embodiments of the moveable maintenance assemblies may include a handle attached to the moveable portion to enable manual operation of the moveable portion from the first position to the second position.

In addition to one or more of the features described above, or as an alternative, further embodiments of the moveable maintenance assemblies may include that the moveable portion includes at least one rail and the fixed portion includes at least one track, wherein the at least one rail is configured to run within the track to guide movement from the first position to the second position.

In addition to one or more of the features described above, or as an alternative, further embodiments of the moveable maintenance assemblies may include that the moveable portion includes at least one roller configured to move along a fixed engagement surface of the fixed portion.

In addition to one or more of the features described above, or as an alternative, further embodiments of the moveable maintenance assemblies may include that the fixed portion includes at least one groove in the fixed engagement surface of the fixed portion, the at least one groove configured to guide movement of the at least one roller.

In addition to one or more of the features described above, or as an alternative, further embodiments of the moveable maintenance assemblies may include at least one component fastener that removably attaches the at least one component to the moveable portion.

In addition to one or more of the features described above, or as an alternative, further embodiments of the moveable maintenance assemblies may include that the elevator car includes one or more securing elements, wherein the securing elements fixedly secure the fixed portion to the elevator car.

According to some embodiments, elevator cars are provided. The elevator cars include an elevator car frame and a moveable maintenance assembly fixedly attached to the frame. The moveable maintenance assembly includes a fixed portion fixedly attached to the frame, the fixed portion forming a portion of the frame of the elevator car, a moveable portion arranged within the fixed portion, the moveable portion moveable relative to the fixed portion from a first position to a second position, and at least one component removably mounted to the moveable portion. The at least one component is removable from the moveable portion when the moveable portion is in the second position.

In addition to one or more of the features described above, or as an alternative, further embodiments of the elevator car may include that the at least one component is at least one of an electronic safety actuator, a safety block, or a roller guide.

In addition to one or more of the features described above, or as an alternative, further embodiments of the elevator car may include that the moveable portion is fixedly attached to the fixed portion when in the first position.

In addition to one or more of the features described above, or as an alternative, further embodiments of the elevator car may include a handle attached to the moveable portion to enable manual operation of the moveable portion from the first position to the second position.

In addition to one or more of the features described above, or as an alternative, further embodiments of the elevator car may include at least one component fastener that removably attaches the at least one component to the moveable portion.

Technical effects of embodiments of the present disclosure include moveable maintenance assemblies of elevator cars that enable easy access to components of the elevator car. Further technical effects include manual operation of such moveable maintenance assemblies and/or portions thereof.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of an elevator system that may employ various embodiments of the present disclosure;

FIG. 2A is a schematic side illustration of an elevator car configured with a moveable maintenance assembly in accordance with an embodiment of the present disclosure;

FIG. 2B is schematic front illustration of the elevator car and moveable maintenance assemblies shown in FIG. 2A;

FIG. 3 is a schematic illustration of a moveable maintenance assembly in accordance with an embodiment of the present disclosure;

FIG. 4A is a schematic side illustration of an elevator car having moveable maintenance assemblies in accordance with the present disclosure installed thereon in a first position;

FIG. 4B is a schematic front illustration of the elevator car of FIG. 4A with the moveable maintenance assemblies in the first position;

FIG. 4C is a schematic side illustration of the elevator car of FIG. 4A with the moveable maintenance assemblies in a second position;

FIG. 4D is a schematic front illustration of the elevator car of FIG. 4A with the moveable maintenance assemblies in the second position;

FIG. 5A is a schematic illustration of a moveable maintenance assembly in accordance with an embodiment of the present disclosure;

FIG. 5B is a schematic illustration of a fixed portion of the moveable maintenance assembly of FIG. 5A;

FIG. 5C is a schematic illustration of a moveable portion of the moveable maintenance assembly of FIG. 5A;

FIG. 6A is a schematic illustration of a moveable maintenance assembly in accordance with another embodiment of the present disclosure;

FIG. 6B is a schematic illustration of a fixed portion of the moveable maintenance assembly of FIG. 6A;

FIG. 6C is a schematic illustration of a moveable portion of the moveable maintenance assembly of FIG. 6A;

FIG. 7A is a schematic illustration of a moveable maintenance assembly in accordance with an embodiment of the present disclosure in a first position;

FIG. 7B is a schematic illustration of the moveable maintenance assembly of FIG. 7A in a second position;

FIG. 8 is a schematic illustration of an elevator car having a moveable maintenance assembly in accordance with an embodiment of the present disclosure installed thereon;

FIG. 9A is a schematic illustration of a moveable maintenance assembly in accordance with an embodiment of the present disclosure in a first position;

FIG. 9B is a schematic illustration of the moveable maintenance assembly of FIG. 9A in the second position;

FIG. 10A is a rear elevation schematic illustration of a moveable portion of a moveable maintenance assembly in accordance with an embodiment of the present disclosure;

FIG. 10B is a side elevation schematic illustration of the moveable portion shown in FIG. 10A;

FIG. 11A is a side elevation schematic illustration of a step of a process for removing components installed to a moveable portion of a moveable maintenance assembly in accordance with an embodiment of the present disclosure;

FIG. 11B is a schematic illustration of another step for removing components from the moveable portion shown in FIG. 11A; and

FIG. 11C is a schematic illustration of another step for removing components from the moveable portion shown in FIG. 11A.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in FIG. X may be labeled “Xa” and a similar feature in FIG. Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

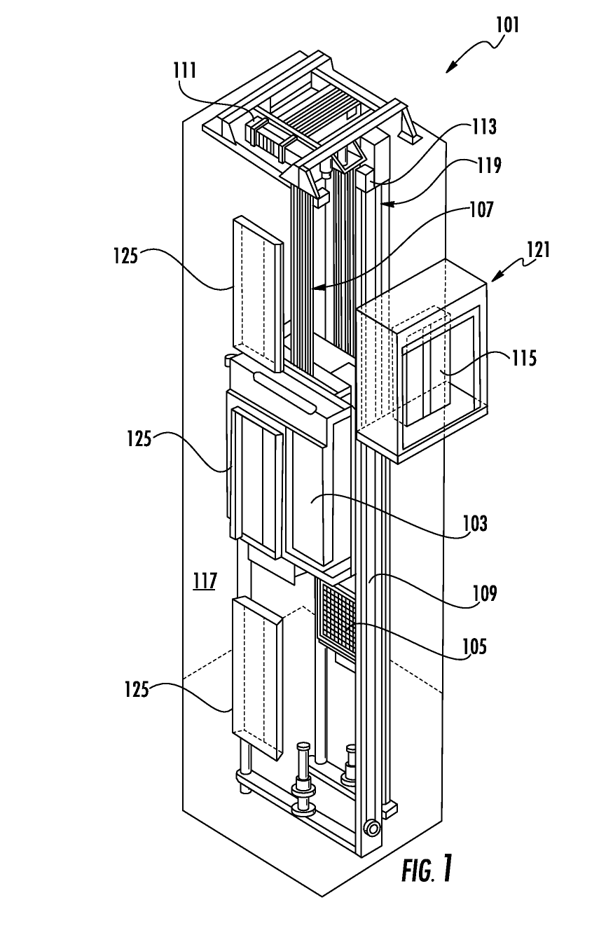

FIG. 1 is a perspective view of an elevator system 101 including an elevator car 103, a counterweight 105, a roping 107, a guide rail 109, a machine 111, a position encoder 113, and an elevator controller 115. The elevator car 103 and counterweight 105 are connected to each other by the roping 107. The roping 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The roping 107 engages the machine 111, which is part of an overhead structure of the elevator system 101. The machine 111 is configured to control movement between the elevator car 103 and the counterweight 105. The position encoder 113 may be mounted on an upper sheave of a speed-governor system 119 and may be configured to provide position signals related to a position of the elevator car 103 within the elevator shaft 117. In other embodiments, the position encoder 113 may be directly mounted to a moving component of the machine 111, or may be located in other positions and/or configurations as known in the art.

The elevator controller 115 is located, as shown, in a controller room 121 of the elevator shaft 117 and is configured to control the operation of the elevator system 101, and particularly the elevator car 103. For example, the elevator controller 115 may provide drive signals to the machine 111 to control the acceleration, deceleration, leveling, stopping, etc. of the elevator car 103. The elevator controller 115 may also be configured to receive position signals from the position encoder 113. When moving up or down within the elevator shaft 117 along guide rail 109, the elevator car 103 may stop at one or more landings 125 as controlled by the elevator controller 115. Although shown in a controller room 121, those of skill in the art will appreciate that the elevator controller 115 can be located and/or configured in other locations or positions within the elevator system 101.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. Although shown and described with a roping system, elevator systems that employ other methods and mechanisms of moving an elevator car within an elevator shaft may employ embodiments of the present disclosure. FIG. 1 is merely a non-limiting example presented for illustrative and explanatory purposes.

Elevator cars can be equipped with safety devices, including but not limited to electronic safety actuators, safety blocks, roller guides, etc., which can be mounted to a structural component of the elevator car, such as a frame element. For example, the structural component can be an upright frame portion that extends from a bottom to a top of the elevator car and provide structural support. Traditionally, such safety devices are located at the top of the upright, and are thus outside the elevator car. Such safety devices are located outside the elevator car and within the elevator shaft to enable engagement and interaction with a guide rail of the elevator system, as will be appreciated by those of skill in the art. The location of the safety devices can cause difficulty in access in order to perform maintenance operations thereon, including but not limited to inspection, diagnostics, repair, and/or replacement.

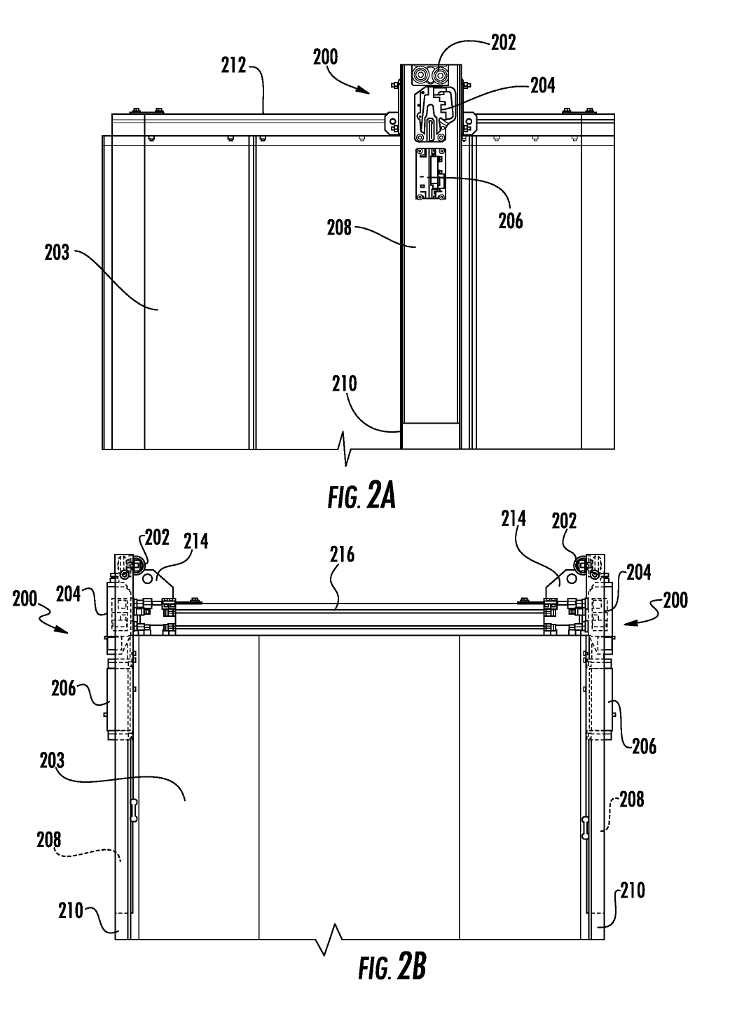

Turning now to FIGS. 2A-2B, schematic illustrations of moveable maintenance assemblies 200 as arranged on an elevator car 203 are shown. The moveable maintenance assemblies 200 include moveable sleeves, supports, or brackets that are moveable relative to the elevator car 203 to enable ease of maintenance to be performed on one or more components of the elevator car 203. As shown in FIG. 2B, two moveable maintenance assemblies 200 are mounted to the elevator car 203. In this particular configuration, the moveable maintenance assemblies 200 support components of the elevator car 203 that engage and/or interact with guide rails of the elevator system (see, e.g., FIG. 3). In this case, the two moveable maintenance assemblies 200 each support components that engage with a guide rail to enable movement of the elevator car 203 within an elevator shaft.

The moveable maintenance assemblies 200 can support or carry one or more elevator components, including, but not limited to, roller guides, rollers, shoes, brakes, emergency components, electrical safety actuators, safety blocks, etc. For example, as shown in FIGS. 2A-2B, the moveable maintenance assemblies 200 each support removably attached components, such as a first component 202, a second component 204, and a third component 206. As schematically shown, the first component 202 is a roller guide, the second component 204 is a safety block, and the third component 206 is an electrical safety actuator. Each of the components 202, 204, 206 are removably mounted or attached to a moveable portion 208 that is moveable within a fixed portion 210. The fixed portions 210 are upright framing and/or structural elements of the elevator car 203. In accordance with some embodiments, the moveable portion 208 is moveable relative to the fixed portion 210 in a translating, sliding, or other similar motion. In some embodiments, the moveable portion 208 can run or slide within a guide or track of the fixed portion 210, as described below.

As shown, one or both of the moveable or fixed portions 208, 210 (or a section thereof) extend above a top 212 of the elevator car 203. As shown, one or more securing elements 214 are positioned to provide secure attachment between the elevator car 203 and the brackets 208, 210. The securing elements 214 can be parts of a crosshead support or frame 216 at the top 212 of the elevator car 203. The moveable portion 208 allows for the components 202, 204, 206 to be moved relative to the top 212 of the elevator car 203 and thus enable easy access to such components. Although shown and described with respect to the top 212 of the elevator car 203, those of skill in the art will appreciate that moveable maintenance assemblies as described here can be installed proximate the bottom of the elevator car, and thus the present disclosure is not limited to positioning of the moveable maintenance assemblies at the top of the elevator car.

Turning now to FIG. 3, a top-down plan schematic illustration of a moveable maintenance assembly 300 in accordance with an embodiment of the present disclosure is shown. The moveable maintenance assembly 300 is mounted to or otherwise fixedly connected to an elevator car 303 by at least two securing elements 314. A fixed portion 310 is fixedly connected to the elevator car 303 as a part of an upright or other frame part and further is attached to the elevator car 303 by the securing elements 314, as shown in FIG. 3. The connection between the fixed portion 310 and the securing elements 314 can be by use of fasteners, welding, bonding, or other mechanism and/or means for fixedly connecting the fixed portion 310 and the securing elements 314. The moveable maintenance assemblies 300 includes the fixed portion 310 and a moveable portion 308 retained within the fixed portion 310. The moveable portion 308 is moveable relative to the fixed portion 310, such as moveable in a direction into/out of the page of FIG. 3, as described below.

The moveable portion 308 supports one or more components, and as shown supports a first component 302 (illustrated as a roller guide), a second component 304 (illustrated as a safety block), and a third component 306 (illustrated as an electrical safety actuator). As shown, the components 302, 304, 306 are positioned about a guide rail 309, with rollers 318 of the first component 302 contacting and running along the guide rail 309 during movement and/or operation of the elevator car 303, as will be appreciated by those of skill in the art.

Each of the components 302, 304, 306 is removably attached to the moveable portion 308 such that the components 302, 304, 306 can be removed from the moveable portion 308, such as for maintenance purposes. For example, as shown, component fasteners 320 can be used to fixedly attach a respective component 302, 304, 306 to the moveable portion 308. Although illustrated as bolts, those of skill in the art will appreciate that the component fasteners 320 can be clips, pins, snaps, screws, slot-and-key, and/or any other type of fastener structure or configuration that fixedly connects the respective component 302, 304, 306 to the moveable portion 308. Further, as shown, at least a portion of the component fasteners 320 are positioned between the moveable portion 308 and the fixed portion 310. However, those of skill in the art will appreciate that other arrangements are possible without departing from the scope of the present disclosure.

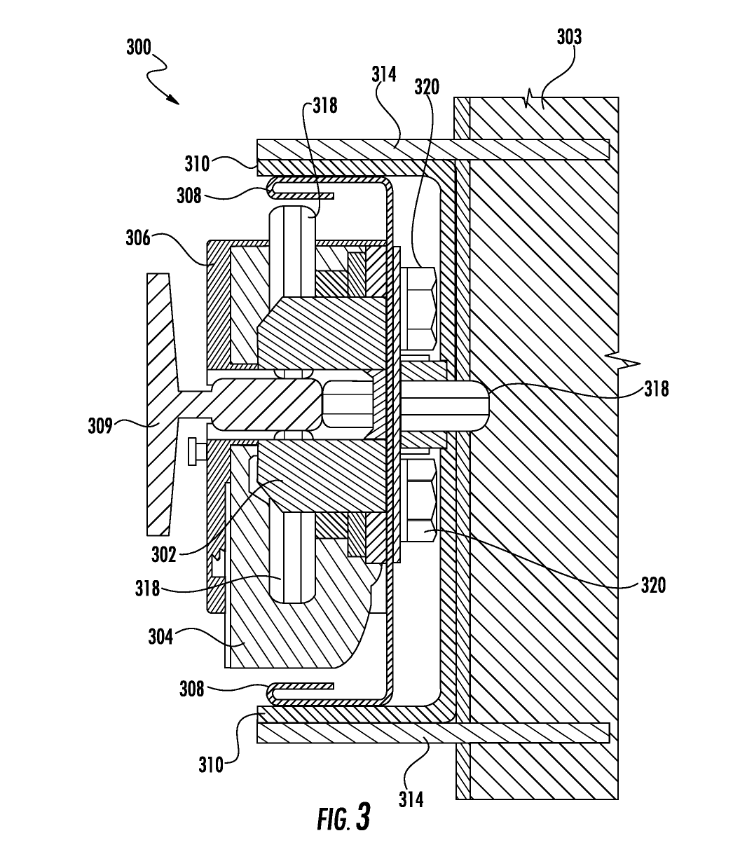

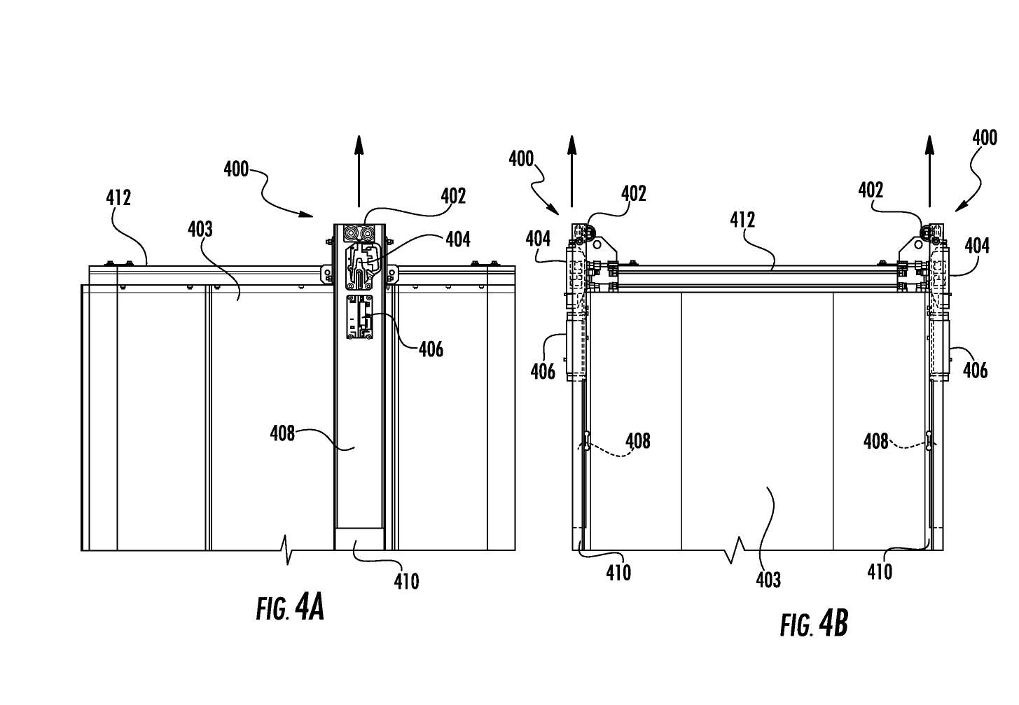

Turning now to FIGS. 4A-4D, schematic illustrations of the operation of moveable maintenance assemblies 400 in accordance with an embodiment of the present disclosure are shown. FIGS. 4A-4B illustrate the moveable maintenance assemblies 400 in a first or operational position wherein the moveable maintenance assemblies 400 are fixedly connected to an elevator car 403. FIG. 4A is a side elevation illustration and FIG. 4B is a front elevation illustration showing the moveable maintenance assemblies 400 in the first position. FIGS. 4C-4D illustrate the moveable maintenance assemblies 400 in a second or maintenance position, with FIG. 4C being a side elevation illustration and FIG. 4D being a front elevation illustration.

The moveable maintenance assemblies 400 are similar to that described above and include multiple components 402, 404, 406 removably attached to a moveable portion 408. The moveable portion 408 is moveably mounted to a fixed portion 410. In the first or operational position, as shown in FIGS. 4A-4B, the moveable portion 408 is securely and fixedly attached to the fixed portion 410 such that the components 402, 404, 406 can engage and interact with a guide rail as in normal operation of the elevator car 403 within an elevator shaft.

In order to perform maintenance on the components 402, 404, 406, a mechanic can operate the moveable maintenance assemblies 400 such that the moveable portion 408 is moved to enable ease of access to the components 402, 404, 406. For example, as shown in FIGS. 4C-4D, the moveable maintenance assemblies 400 are shown in a second or maintenance position. As shown, the moveable portion 408 is translated or moved relative to the fixed portion 410 and thus moved relative to a top 412 of the elevator car 403.

The moveable portion 408 can be manually movable using a handle or other manual operation feature (e.g., hooks, loops, holes, bars, grips, etc.), as described below. In the second position, as illustratively shown, one or more of the components 402, 404, 406 can be removed from the moveable portion 408 to enable ease of inspection, repair, replacement, etc. After a maintenance operation is performed, the components 402, 404, 406 can be re-attached to the moveable portion 408 and the moveable portion 408 can be moved from the second position to the first position. In the first position, the moveable portion 408 can be re-attached and fixedly connected to the fixed portion 410.

The movements of the movable portion relative to the fixed portion of moveable maintenance assemblies in accordance with the present disclosure can be enabled through various mechanisms. For example, sliding rails, rollers, tracks, slot-groove arrangements, etc. can all be used to enable movement of the movable portion relative to the fixed portion.

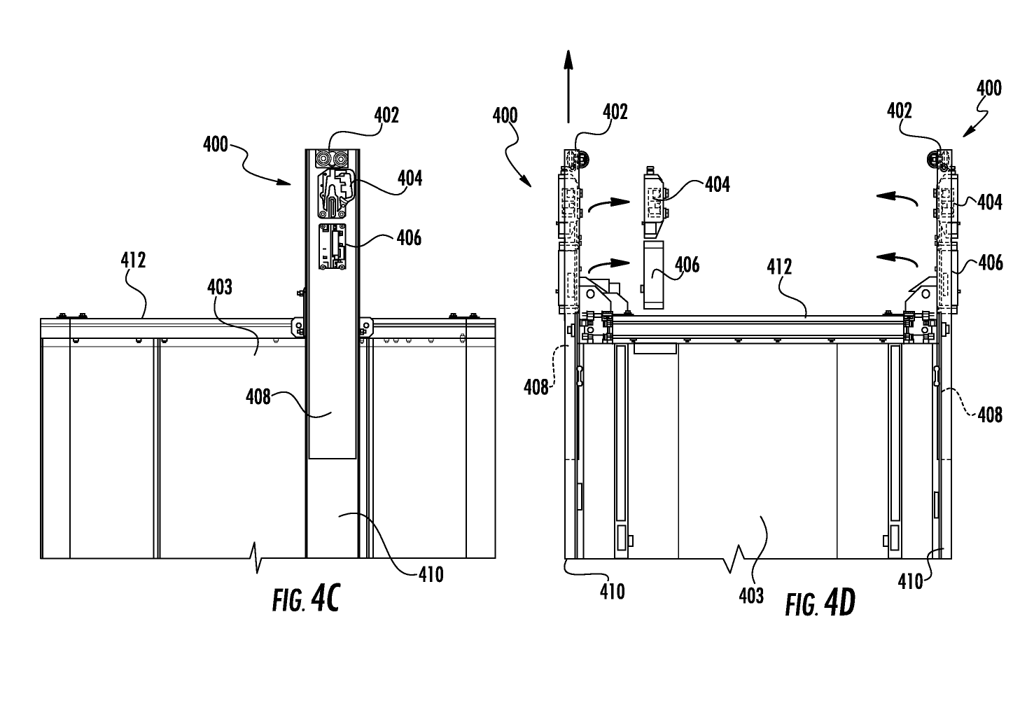

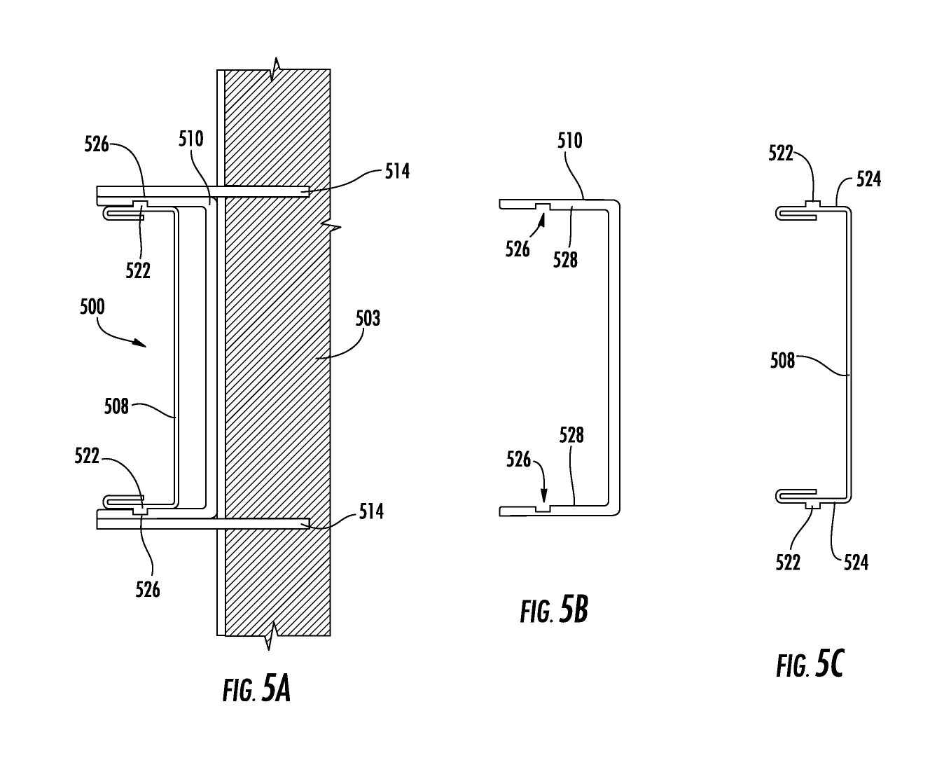

Turning to FIGS. 5A-5C, a non-limiting schematic illustration of a moveable maintenance assembly 500 in accordance with the present disclosure is shown. The moveable maintenance assembly 500 is configured to support one or more components thereon, as described above. The moveable maintenance assembly 500 is fixed to an elevator car 503. Similar to that described above, the moveable maintenance assembly 500 is attached to the elevator car 503 by securing elements 514. As shown, a fixed portion 510 of the moveable maintenance assembly 500 is fixedly connected or attached to the securing elements 514, such as by welding, adhesives, fasteners, etc. A moveable portion 508 is movably arranged within and to the fixed portion 510. In the embodiment of FIGS. 5A-5C, the moveable portion 508 includes a rail 522 on an engagement surface 524. The rail 522 is configured to move or run within a track 526 formed in a fixed engagement surface 528 of the fixed portion 510. FIG. 5B illustrates the fixed portion 510 and FIG. 5C illustrates the moveable portion 508.

As shown in the embodiment of FIGS. 5A-5C, two rails 522 are provided on the moveable portion 508 and two respective tracks 528 are provided on the fixed portion 510. Those of skill in the art will appreciate that the position and/or number of rails/tracks can be varied without departing from the scope of the present disclosure. In one non-limiting variation, a single rail can be provided on the right-most surface of the moveable portion 508 (as shown and oriented in FIG. 5C) and a respective single track can be provided on the inner, right surface of the fixed portion 510 (as shown and oriented in FIG. 5B). Other variations and/or combinations thereof are possible without departing from the scope of the present disclosure.

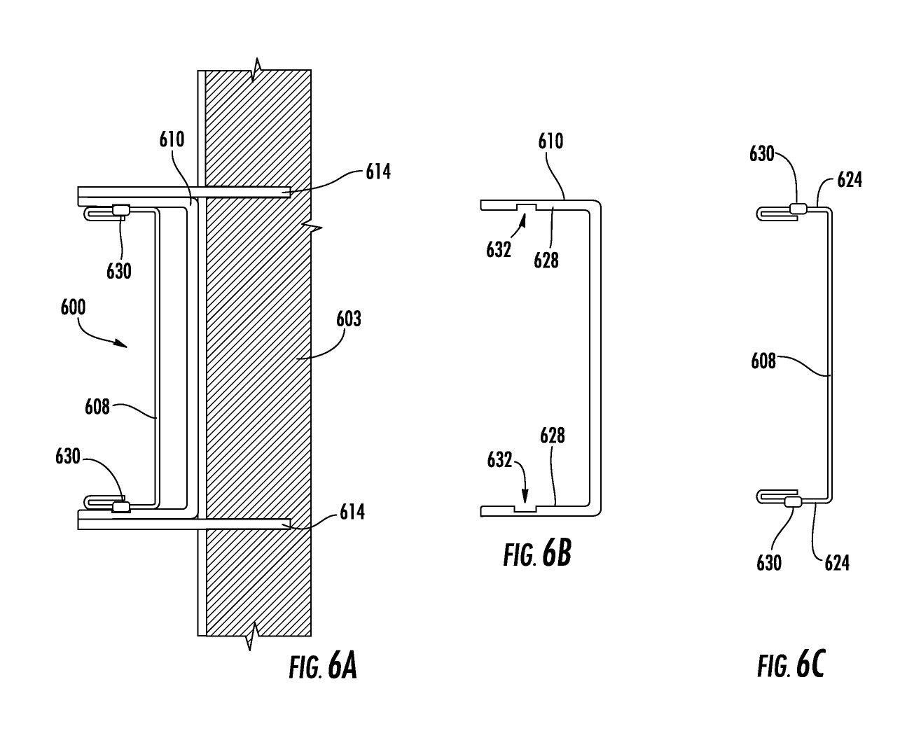

Turning to FIGS. 6A-6C, a non-limiting schematic illustration of a moveable maintenance assembly 600 in accordance with the present disclosure is shown. The moveable maintenance assembly 600 is configured to support one or more components thereon, as described above. The moveable maintenance assembly 600 is fixed to an elevator car 603. Similar to that described above, the moveable maintenance assembly 600 is attached to the elevator car 603 by securing elements 614. As shown, a fixed portion 610 of the moveable maintenance assembly 600 is fixedly connected or attached to the securing elements 614, such as by welding, adhesives, fasteners, etc. A moveable portion 608 is movably arranged within and to the fixed portion 610. In the embodiment of FIGS. 6A-6C, the moveable portion 608 includes rollers 630 on a moveable engagement surface 624. The rollers 630 are configured to run or move within an optional groove 632 formed in a fixed engagement surface 628 of the fixed portion 610. FIG. 6B illustrates the fixed portion 610 and FIG. 6C illustrates the moveable portion 608.

As discussed above with respect to the embodiment of FIGS. 5A-5C, those of skill in the art will appreciate that alternative arrangements of rollers can be employed without departing from the scope of the present disclosure. Further, as noted, the groove 632 is optional, and in some embodiment may be omitted such that the rollers 630 contact and roll directly along the fixed engagement surface 628. Moreover, those of skill in the art will appreciate that other mechanisms and/or means to enable the moveable portion to move relative to the fixed portion of the moveable maintenance assembly 600 are possible. For example, without limitation, bearings, grease or other lubricant, etc. can be used to enable relative movement of the moveable portion 608 to the fixed portion 610.

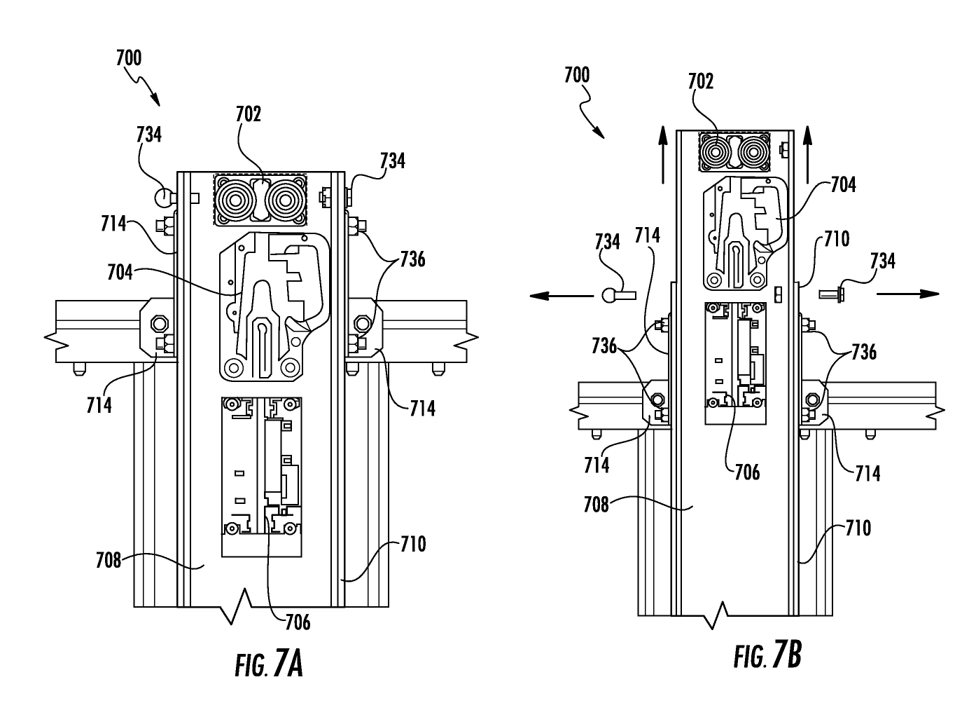

Turning now to FIGS. 7A-7B, schematic illustrations of a moveable maintenance assembly 700 in accordance with an embodiment of the present disclosure are shown. The moveable maintenance assembly 700 includes a moveable portion 708 and a fixed portion 710, similar to that shown and described above. FIG. 7A illustrates the moveable maintenance assembly 700 in a first, operational position, with the moveable portion 708 fixedly attached to the fixed portion 710. FIG. 7B illustrates the moveable maintenance assembly 700 in a second, maintenance position, with the moveable portion 708 moved relative to the fixed portion 710.

As shown, the moveable portion 708 can be fixed to the fixed portion 710 by one or more mounting fasteners 734. The mounting fasteners 734, as shown, are illustrated as a pin and a bolt and nut. However, those of skill in the art will appreciate that other types of removable or releasable mounting fasteners can be employed without departing from the scope of the present disclosure. When the mounting fasteners 734 are engaged, the mounting fasteners 734 fixedly and rigidly secure the moveable portion 708 to the fixed portion 710, thus enabling secure operation of components 702, 704, 706 that are mounted to the moveable portion 708. As discussed above, the components 702, 704, 706 can include a safety block or other components that engage with a guide rail of the elevator system. As such, the securing and stability provided by the engagement of the mounting fasteners 734 can be selected to provide proper and/or adequate fixing of the moveable portion 708 to the fixed portion 710.

Also shown in FIGS. 7A-7B, the fixed portion 710 is fixedly attached or secured to securing elements 714 that are attached to or part of a frame of an elevator car (as described above). As shown, one or more securing fasteners 736 are provided to secure the fixed portion 710 to the frame of the elevator car at the securing elements 714.

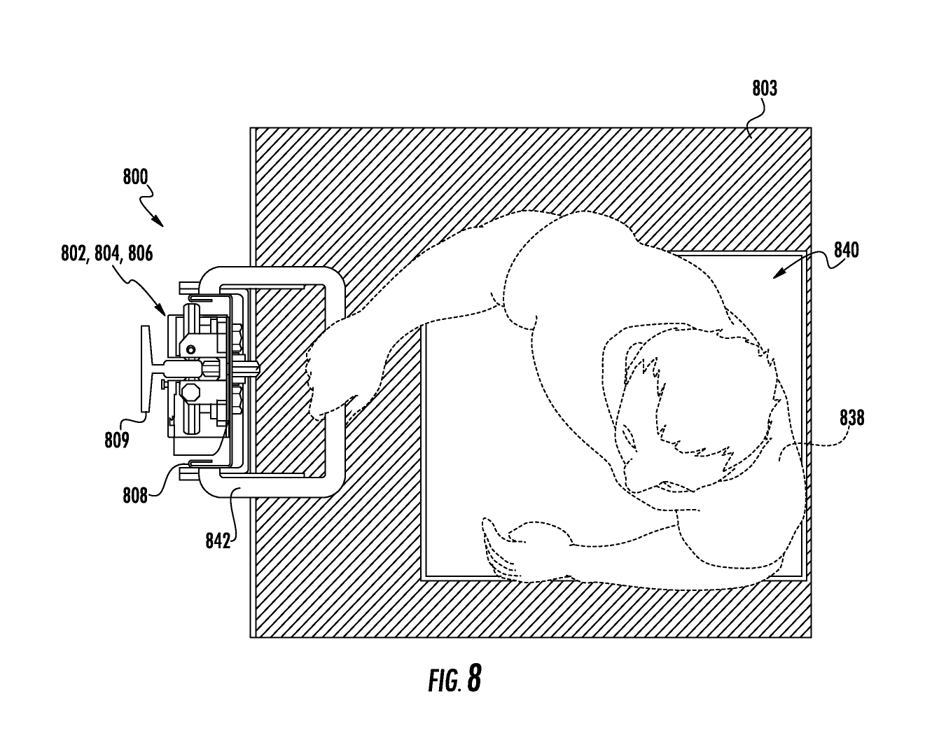

Turning now to FIG. 8, a schematic illustration of a mechanic 838 accessing components 802, 804, 806 that are mounted on a moveable portion 808 of a moveable maintenance assembly 800 in accordance with an embodiment of the present disclosure is shown. As shown, the mechanic 838 can access the moveable maintenance assembly 800 through an opening 840 in a roof or top of an elevator car 803. The mechanic 838 can then remove mounting fasteners (e.g., as shown in FIGS. 7A-7B) to allow for the moveable portion 808 to move as shown and described herein. In the embodiment of FIG. 8, as shown, the moveable maintenance assembly 800 includes a handle 842 to allow for manual operation and movement of the moveable portion 808 of the moveable maintenance assembly 800. Accordingly, the mechanic 838 can operate the moveable maintenance assembly 800 from a first, secured and operational position to a second, maintenance position such that the mechanic 838 can perform maintenance operations on one or more of the components 802, 804, 806. As discussed above, the mechanic 838 can remove one or more of the components 802, 804, 806 from the moveable portion 808 and thus inspect, repair, replace, or perform other maintenance operations thereon.

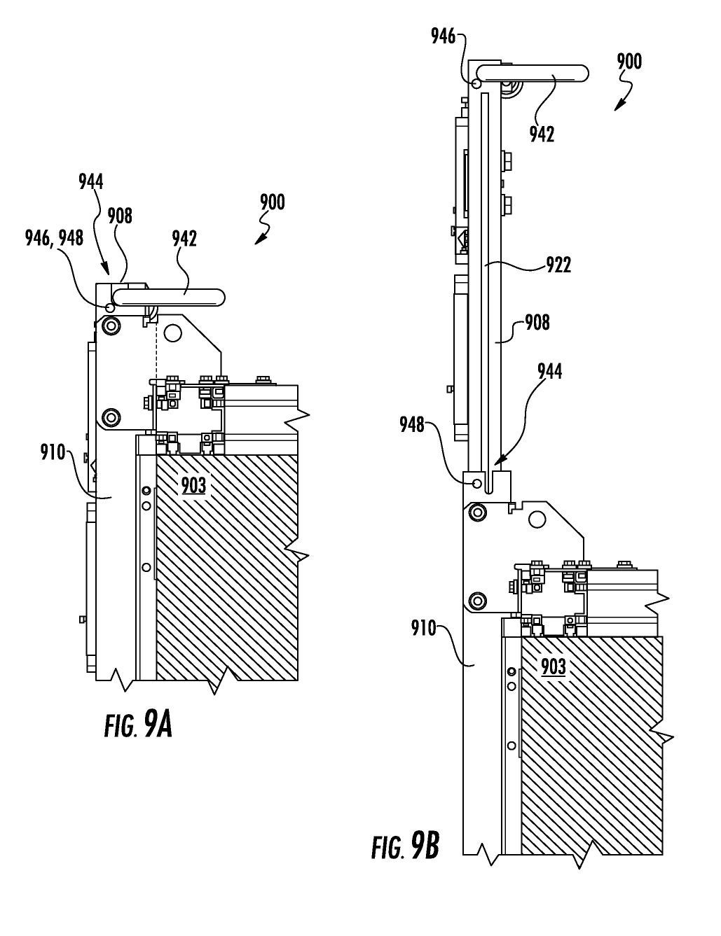

Turning now to FIGS. 9A-9B, schematic illustrations of a moveable maintenance assembly 900 in accordance with an embodiment of the present disclosure are shown. FIG. 9A illustrates the moveable maintenance assembly 900 in a first position and FIG. 9B illustrates the moveable maintenance assembly 900 in a second position. As shown, the moveable maintenance assembly 900 is similar to that shown and described above. For example, the moveable maintenance assembly 900 includes a moveable portion 908 and a fixed portion 910 that is fixed to an elevator car 903. As shown, a portion of a handle 942 of the moveable portion 942 fits within a recess 944 of the fixed portion 910. The handle 942 is usable to move the moveable portion 908 from the first position (FIG. 9A) to the second position (FIG. 9B). Also shown in FIGS. 9A-9B are apertures 946, 948 within the moveable and fixed portions 908, 910, respectively. The apertures 946, 948 are aligned when the moveable portion 908 is in the first position and allows for mounting fasteners (e.g., as shown in FIGS. 7A-7B) to secure the moveable portion 908 to the fixed portion 910.

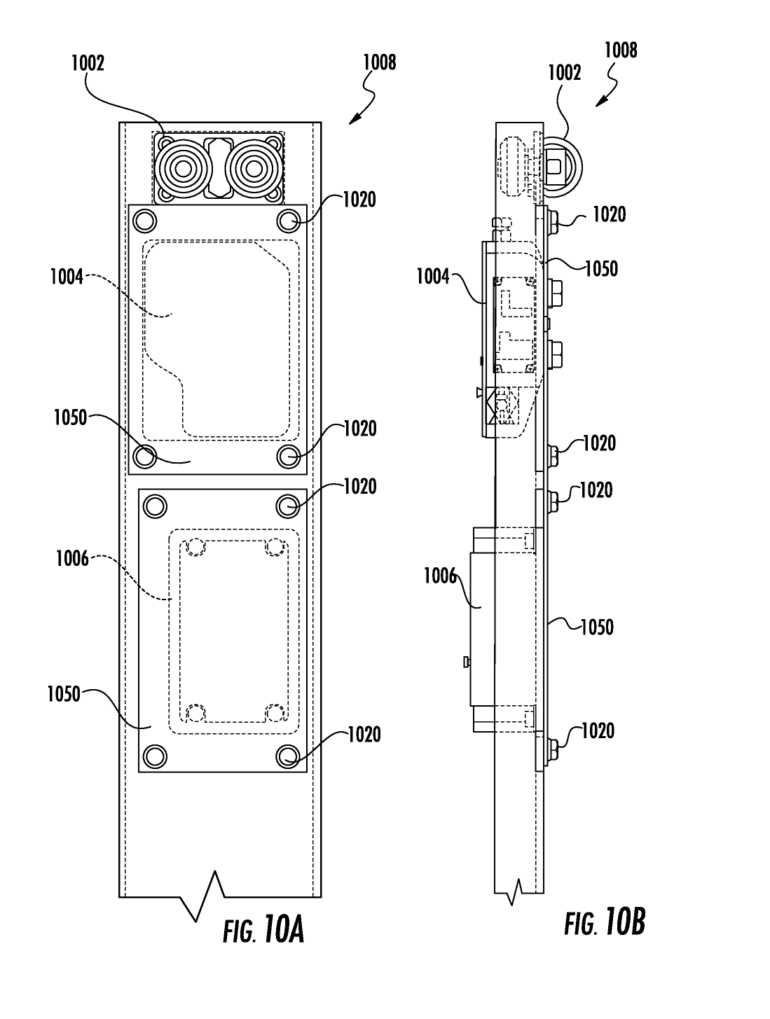

Turning now to FIGS. 10A-10B, schematic illustrations of a moveable portion 1008 having components 1002, 1004, 1006 installed thereon are shown. The moveable portion 1008 is configured to move within and/or along a fixed portion, as described above. As shown, one or more of the components 1002, 1004, 1006 are mounted to support plates 1050 that are removably attached to the moveable portion 1008 by one or more component fasteners 1020. When the moveable portion 1008 is moved into the second position (as shown and described above), a mechanic can remove the component fasteners 1020 and thus access the components 1002, 1004, 1006 that are mounted to the support plates 1050.

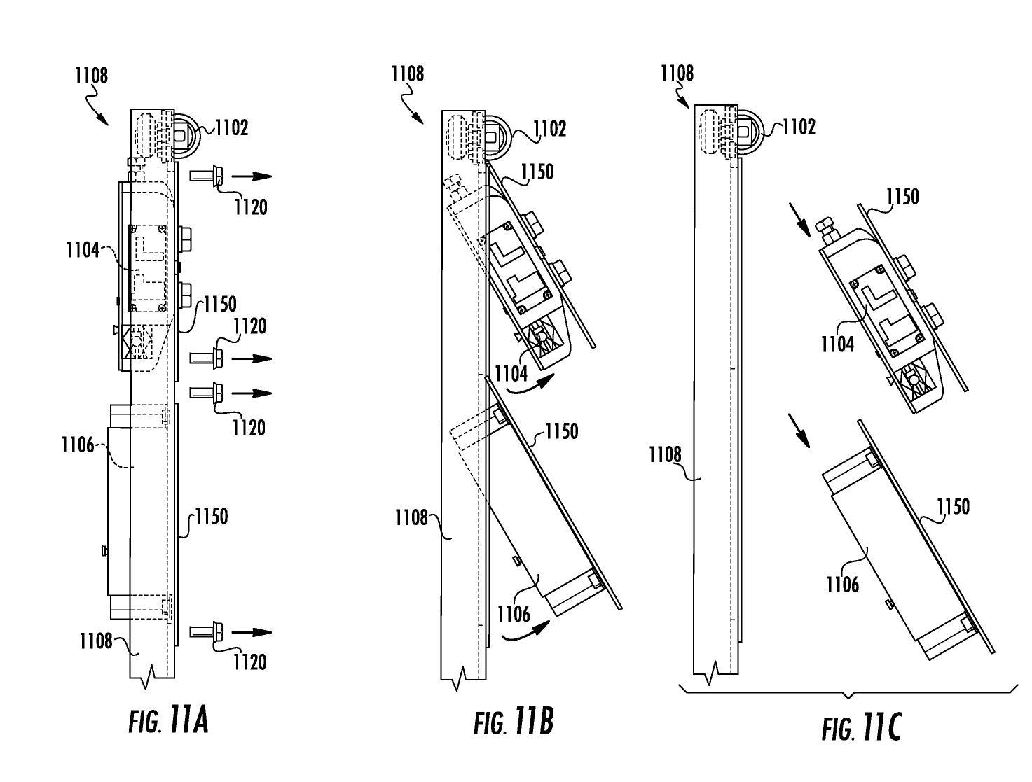

For example, turning now to FIGS. 11A-11C, schematic illustrations of the removal of components from a moveable portion 1108 of a moveable maintenance assembly in accordance with the present disclosure is shown. The moveable portion 1108 have three components 1102, 1104, 1106 installed thereon. As shown, the second and third components 1104, 1106 are mounted to support plates 1150, which in turn are removably attached and mounted to the moveable portion 1108. The support plates 1150 are fixed to the moveable portion 1108 by one or more component fasteners 1120. To access the components 1104, 1106, one or more component fasteners 1120 are removed, as shown in FIG. 11A. With the component fasteners 1120 removed, the support plates 1150 can be separated and removed from the moveable portion 1108, as schematically shown in FIGS. 11B-11C.

Advantageously, embodiments provided herein are directed to moveable maintenance assemblies for elevators. Specifically, moveable maintenance assemblies in accordance with the present disclosure enable a user of such system to perform elevator maintenance without fully entering an elevator shaft. That is, as will be appreciated by those of skill in the art, a mechanic or other person may be able to access components of the elevator car (e.g., roller guides, safety actuators, etc.) while the mechanic is at least partially located within the elevator car.

As used herein, the use of the terms “a,” “an,” “the,” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity).

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the spirit and scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description, but is only limited by the scope of the appended claims.

What is claimed is:

1. A moveable maintenance assembly for an elevator car, the moveable maintenance assembly comprising:
a fixed portion fixedly attached to the elevator car, the fixed portion forming a portion of a frame of the elevator car;
a moveable portion arranged within the fixed portion, the moveable portion moveable relative to the fixed portion from a first position to a second position; and
at least one component removably mounted to the moveable portion;
wherein the at least one component is removable from the moveable portion when the moveable portion is in the second position.

2. The moveable maintenance assembly of claim 1, wherein the at least one component is at least one of an electronic safety actuator, a safety block, or a roller guide.

3. The moveable maintenance assembly of claim 1, wherein the moveable portion is fixedly attached to the fixed portion when in the first position.

4. The moveable maintenance assembly of claim 3, further comprising one or more mounting fasteners to fix the moveable portion in the first position, the one or more mounting fasteners removable to enable the moveable portion to move relative to the fixed portion.

5. The moveable maintenance assembly of claim 1, further comprising a handle attached to the moveable portion to enable manual operation of the moveable portion from the first position to the second position.

6. The moveable maintenance assembly of claim 1, wherein the moveable portion includes at least one rail and the fixed portion includes at least one track, wherein the at least one rail is configured to run within the track to guide movement from the first position to the second position.

7. The moveable maintenance assembly of claim 1, wherein the moveable portion includes at least one roller configured to move along a fixed engagement surface of the fixed portion.

8. The moveable maintenance assembly of claim 7, wherein the fixed portion includes at least one groove in the fixed engagement surface of the fixed portion, the at least one groove configured to guide movement of the at least one roller.

9. The moveable maintenance assembly of claim 1, further comprising at least one component fastener that removably attaches the at least one component to the moveable portion.

10. The moveable maintenance assembly of claim 1, wherein the elevator car includes one or more securing elements, wherein the securing elements fixedly secure the fixed portion to the elevator car.

11. An elevator car comprising:
an elevator car frame;
a moveable maintenance assembly fixedly attached to the frame, the moveable maintenance assembly comprising:
a fixed portion fixedly attached to the frame, the fixed portion forming a portion of the frame of the elevator car;
a moveable portion arranged within the fixed portion, the moveable portion moveable relative to the fixed portion from a first position to a second position; and
at least one component removably mounted to the moveable portion;
wherein the at least one component is removable from the moveable portion when the moveable portion is in the second position.

12. The elevator car of claim 11, wherein the at least one component is at least one of an electronic safety actuator, a safety block, or a roller guide.

13. The elevator car of claim 11, wherein the moveable portion is fixedly attached to the fixed portion when in the first position.

14. The elevator car of claim 11, further comprising a handle attached to the moveable portion to enable manual operation of the moveable portion from the first position to the second position.

15. The elevator car of claim 11, further comprising at least one component fastener that removably attaches the at least one component to the moveable portion.
